(19) United States
(12) Patent Application Publication
(10) Pub. No.: US 2026/0351121 A1
(43) Pub. Date: Nov. 5, 2026

(54) METHOD FOR SELECTING AN ACTIVATION LOGIC OF AN INERTING SYSTEM OF AN AIRCRAFT FUEL TANK

(71) Applicant: SAFRAN AEROSYSTEMS, PLAISIR (FR)

(72) Inventor: Thibaut VOZY, MOISSY CRAMAYEL (FR)

(21) Appl. No.: 19/112,475

(22) PCT Filed: Sep. 15, 2023
(86) PCT No.: PCT/FR2023/051413

§ 371 Date: Mar. 17, 2025

(30) Foreign Application Priority Data
Sep. 20, 2022 (FR) 2209466

(51) Int. Cl. G08G 5/32; B64D 37/32; B64D 45/00

(52) U.S. Cl. CPC G08G 5/32; B64D 37/32; B64D 45/00; B64D 2045/0085

(57) ABSTRACT

A method for selecting an activation logic of an inerting system of at least one fuel tank of an aircraft for at least one mission of the aircraft, the method including transmitting data relating to the preparation of the mission to a computer; estimating, by the computer, a plurality of N risks of flammability of the fuel contained in the fuel tank, N being a non-zero natural number, each risk of flammability being estimated from: a single activation logic of the inerting system selected from among a plurality of N activation logics of the inerting system; and data relating to the preparation of the mission; selecting an activation logic, from among the plurality of N activation logics, on the basis of the plurality of N estimated flammability risks and on the basis of a condition relating to the inerting system.

### TECHNICAL FIELD OF THE INVENTION

The technical field of the invention is that of fuel tank inerting systems of aircraft.

The present invention relates to a method for selecting an activation logic for an inerting system of an aircraft fuel tank.

### TECHNOLOGICAL BACKGROUND OF THE INVENTION

The purpose of inerting systems is to secure a volume comprising vapours whose mixture with a reactive product, such as air for example, exhibits a flammability risk by replacing said reactive product with a neutral gas, the neutral gas being nitrogen or carbon dioxide for example.

In particular, aircraft Fuel Tank Inerting Systems, referred to as FTIS, are automatic systems without pilot control for the purpose of preventing formation of a mixture of flammable fuel vapours in one or more fuel tanks, by preparing the engine bleed air and then generating and introducing a neutral gas into the fuel tanks.

Document EP3176093A1 relates to an aircraft fuel tank inerting system comprising an inerting gas generator supplied with purge air and means for distributing the inerting gas into the fuel tank or tanks, connected to the inerting gas generator and incorporating a device for measuring the amount of oxygen present in said inerting gas. An inerting gas generator of the state of the art comprises at least one Air Separation Module (ASM) for producing nitrogen from the supply air.

However, the engine bleed air for supplying the inerting systems is diverted from at least one turbojet engine of the aircraft, which therefore causes a loss of pressurised air that could, for example, serve to propel the aircraft and pressurise and air-condition the passenger cabin. In addition, the pressurised air used to supply the inerting systems is a cause of wear on the inerting system pieces. The wear of some inerting system pieces does not make it possible to have components the life time of which is longer than that of the aeroplane, which implies/requires that several maintenance operations are required over the life of the aircraft.

There is therefore a need to reduce the consumption of air supplied to an inerting system and to limit wear on pieces of said inerting system.

### SUMMARY OF THE INVENTION

The invention offers a solution to the problems previously discussed by adapting the operation and activation of the inerting system without impacting flight safety, while reducing air consumption and limiting wear on the pieces of the inerting system.

A first aspect of the invention relates to a method for selecting an activation logic for an inerting system for at least one fuel tank of an aircraft for a mission of the aircraft, the method including the following steps of:
Transmitting data relating to the preparation of the mission to a calculator;
Estimating, by the calculator, a plurality of N flammability risks of fuel included in the fuel tank, N being a non-zero natural number, each flammability risk being estimated from:
   a single activation logic of the inerting system selected from a plurality of N activation logics of the inerting system; and
   data relating to the preparation of the mission;
Selecting an activation logic, among the plurality of N activation logics, from the plurality of N flammability risks estimated and from a condition relating to the inerting system.

By “activation logic of the inerting system», it is meant a time chart representing the course of the operating state of the inerting system over time, wherein the inerting system can be in a so-called activated operating state for at least one part of the time and/or can be in a so-called deactivated operating state for at least another part of the time. Thus, the horizontal axis of the time chart represents time and the vertical axis of the time chart represents two logical states of the operating state of the inerting system: a first, so-called “activated” state and a second, so-called “deactivated” state. The part of time for which the inerting system is in an activated operating state includes a plurality of non-necessarily consecutive time periods, said time periods being for example spaced from time periods for which the inerting system is in a deactivated state.

When the inerting system is in a so-called “activated” operating state, the electrical system emits electric power to the inerting system, which can be supplied with air taken from the engine.

When the inerting system is in a so-called “deactivated”operating state, the electrical system is in electrical standby and does not emit electric power to the inerting system, which is not supplied with air taken from the engine.

The time over which the activation logic is defined is the mission time defined by the certification regulations defined by the FAA (Federal Aviation Administration) in document AC 25.981-2A dated 19 Sep. 2008 and entitled “FUEL TANK FLAMMABILITY REDUCTION MEANS” and its appended documents as the time that elapses from the start of the aircraft preparation for the flight, and then during the flight until all the aircraft payload is unloaded and all the passengers and crew have disembarked after the flight has landed. Thus, the mission comprises a first phase where the aircraft is on the ground before a flight and starts when the aircraft is prepared for the flight, a second phase where the aircraft is in flight, and a third phase where the aircraft is on the ground again after said flight, the third phase ending when all the payload of said aircraft is unloaded and all the passengers and crew have disembarked, the first, second and third phases being successive.

FIG. 1 is an example of activation logic.

By “flammability risk”, it is meant the ratio or percentage of the cumulative time during which the fuel in a tank is flammable, over the mission time, times being expressed in minutes.

Advantageously, the activation logic selected enables the fuel tank inerting system to be fully or partially deactivated without impacting flight safety, as flammability risks are taken into account at the time of selection. The activation logic selected also takes a condition relating to the inerting system into account.

Further to the characteristics just discussed in the preceding paragraph, the method according to one aspect of the invention may have one or more additional characteristics among the following, considered individually or according to any technically possible combination:
the flammability risk estimated from the activation logic selected is less than or equal to a reference flammability risk estimated from a reference activation logic. Advantageously, if the reference activation logic is, for example, an activation logic in which the inerting system is activated for the entire mission time, the protection against the flammability of the fuel achieved by virtue of the activation logic selected is equivalent to the protection achieved when the inerting system is activated for the entire mission time. Thus, the invention makes it possible to avoid generating an inert gas when there is no flammability risk of the fuel.
the mission comprises a phase during which the aircraft is in flight and the data relating to the aircraft mission preparation comprise at least one of the following data:
   Type of aircraft;
   Mass of fuel included in the aircraft fuel tank prior to flight;
   Temperature of fuel included in the aircraft fuel tank prior to flight;
   Flight destination;
   Flight profile, the flight profile comprising at least one of the following data:
      Geographical position of the aircraft during flight;
      Altitude of the aircraft during flight;
      Air speed or Mach number during flight;
each flammability risk among the N flammability risks is further estimated from meteorological data. Advantageously, the data relating to the preparation of the mission combined with the meteorological data make it possible to accurately estimate each flammability risk, especially by virtue of the meteorological data which makes it possible to know the temperature over the entire mission and in particular over the flight profile and not just at a single instant t, in order to plan in advance an activation logic making it possible, for example, to deactivate the inerting system at some geographical positions with very low temperatures, not causing a flammability danger of the fuel.
each flammability risk of fuel included in the fuel tank is further estimated from the flash point of fuel included in the fuel tank, the flash point of the fuel being the temperature at which fuel included in the tank emits sufficient flammable gases to form with ambient air a gas mixture which ignites from a flame.
Advantageously, knowing the flash point makes it possible to obtain a more accurate flammability risk.
N is between 2 and 10. As a reminder, N is the number of activation logics included in the plurality of N activation logics in which a logic is selected according to several conditions.
Each activation logic is a time chart representing the operating state of the inerting system over time during the mission, wherein the inerting system can be in a so-called activated operating state during at least one part of the mission and/or can be in a so-called deactivated operating state during at least another part of the mission.
the condition relating to the inerting system concerns at least one of:
   Energy consumption of the inerting system;
   Wear of at least one piece of the inerting system;
   Air supply pressure to the inerting system.
      Advantageously, the condition relating to the inerting system makes it possible to obtain an activation logic according to one criterion desired by an operator. When the condition relating to the inerting system relates to the energy consumption of the inerting system, the activation logic selected makes it possible, for example, to reduce air/energy consumption and to reuse hot air saved when the inerting system is deactivated in order to generate propulsion.

A second aspect of the invention relates to a method for activating the fuel tank inerting system of an aircraft, the method including the following steps of:
Transmitting to the aircraft the activation logic selected by the selection method according to the first aspect of the invention;
Activating the inerting system according to the activation logic selected. Advantageously, the method according to the second aspect of the invention enables the inerting system to be activated according to the activation logic selected.

Another aspect of the invention relates to a computer program product comprising instructions which, when the program is executed by a computer, cause the same to implement the method according to the first aspect of the invention.

Another aspect of the invention relates to a computer-readable recording support comprising instructions which, when executed by a computer, cause the same to implement the method according to the first aspect of the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 represents an example of the activation logic of an aircraft fuel tank inerting system.

FIG. 2 represents a diagram of a system configured to implement a method for selecting an activation logic according to a first aspect of the invention and a method for activating an inerting system according to a second aspect of the invention.

FIG. 3 represents a block diagram of the method for selecting an activation logic for an inerting system according to the first aspect of the invention.

FIG. 4 represents an example of the activation logic of an aircraft fuel tank inerting system when the activation logic is selected according to one condition relating to the supply pressure of the inerting system.

FIG. 5 represents a block diagram of the method for activating an inerting system according to the second aspect of the invention.

FIG. 6 is an example of implementation of the method for selecting an activation logic and the method for activating an inerting system.

### DETAILED DESCRIPTION

The figures are set forth by way of indicating and in no way limiting purposes of the invention.

FIG. 2 represents a system 30 comprising an aircraft 31 and a calculator 32.

The aircraft 31 is an aeroplane or helicopter, for example.

The aircraft 31 includes at least one avionics system 311.

According to one embodiment, the avionics system 311 is configured to allow a pilot to prepare a mission of the aircraft 31 and to generate data relating to the preparation of the mission. In this embodiment, the avionics system 311 is further configured to establish a two-way exchange channel with the calculator and transmit data relating to the preparation of the mission to the calculator 32.

The two-way exchange channel between the avionics system 311 and the calculator 32 is preferably secure and able to use one or more communication technologies of the state of the art, especially at least one of the following communication technologies:
a radio communications network, for example a radio beam.
a Bluetooth® communication standard.
the internet network, by virtue of different mobile telephony standards such as 3G, 4G and/or 5G.
a wired communications network.
a satellite antenna.

According to another embodiment, the aircraft 31 comprises a portable electronic device not represented, able to communicate with the avionics system 311 of the aircraft 31, and which is configured to allow the pilot to prepare the mission. The portable electronic device is also referred to as a portable electronic mission preparation device.

The portable electronic device preferably includes a network interface including an antenna, a memory and a processor, for example a microprocessor.

The portable electronic device further comprises one or more means for acquiring and displaying data, for example a touch screen.

The portable electronic device is a tablet, for example.

The portable electronic device may be included in the avionics system 311 or be external to the avionics system 311.

When the portable electronic device is external to the avionics system 311, the portable electronic device is configured to transmit data relating to the preparation of the mission to the avionics system 311 which can then communicate these data to the calculator 32; or the portable electronic device is further configured to transmit data relating to the preparation of the mission directly to the calculator 32 via a two-way exchange channel. In this case, and similarly to what has been said for the avionics system, the two-way exchange channel between the portable electronic device and the calculator 32 is preferably secure and able to use one or more communication technologies of the state of the art, especially at least one of the following communication technologies:
a radio communications network, for example a radio beam.
a Bluetooth® communication standard.
the internet network, by virtue of different mobile telephony standards such as 3G, 4G and/or 5G.
a wired communications network.
a satellite antenna.

The aircraft further comprises an electrical system 312 and a fuel system 313.

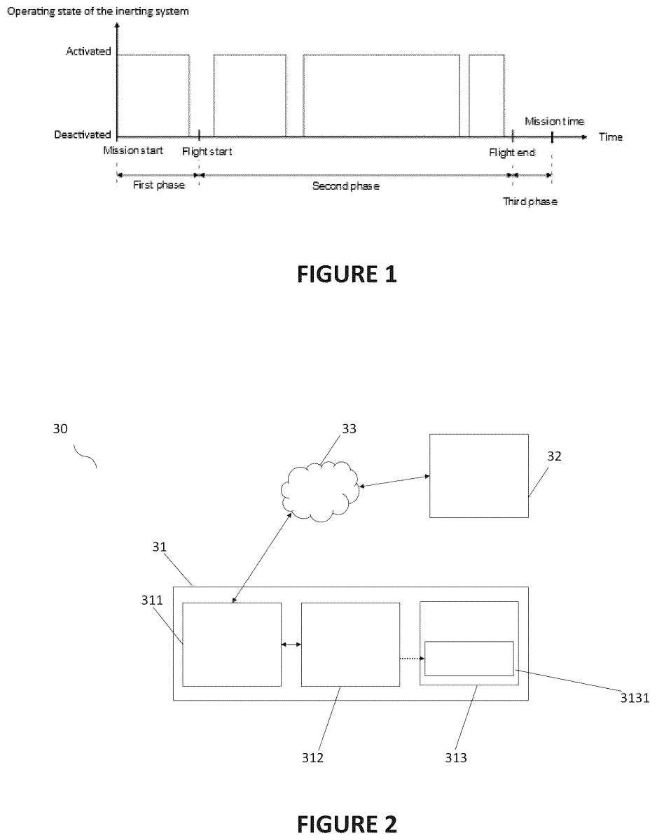

The fuel system 313 comprises at least one fuel tank, not represented in FIG. 1, and a fuel tank inerting system 3131.

The electrical system 312 is configured to receive data transmitted by the avionics system 311 and to transmit electric power to the inerting system.

The calculator 32 includes a network interface including an antenna not represented, a memory and a processor, for example a microprocessor.

The calculator 32 is preferably a computer.

According to one embodiment, the system comprises a plurality of calculators forming a computing centre. In the following, calculator 32 and computing centre are one and the same.

One aspect of the invention relates to a method for selecting an activation logic for the inerting system 3131 of the fuel tank of an aircraft 31 for at least one mission of the aircraft 31.

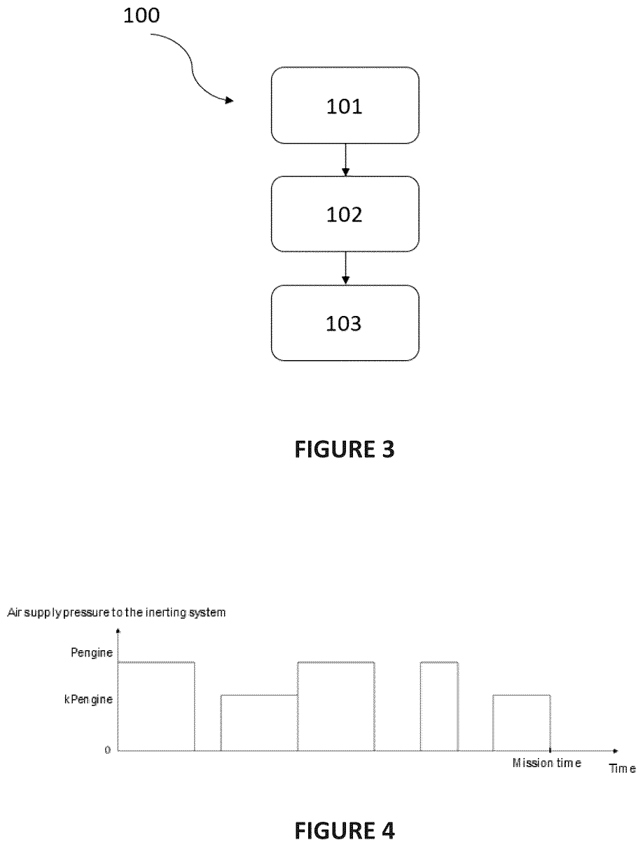

FIG. 3 is a block diagram showing the steps in such a method 100.

The method 100 comprises a first step 101 of transmitting data relating to the preparation of the mission to the calculator 32.

The mission comprises a phase, previously defined as the second phase, during which the aircraft is in flight. Data relating to the preparation of the mission of the aircraft 31 preferably comprise at least one of the following data: type of aircraft 31 which will make the flight, mass of fuel included in the fuel tank of the aircraft 31 before the flight, temperature of fuel included in the fuel tank of the aircraft 31 before the flight, profile of the flight.

The data relating to the preparation of the mission may further comprise the geographical position of the aircraft throughout the mission, for example.

The flight profile can include at least one of the following data: geographical position of the aircraft 31 during the flight, altitude of the aircraft 31 during the flight, air speed, Mach number during the flight.

Furthermore, meteorological data are downloaded by the calculator 32 from an external database which can be queried by the calculator 32. The meteorological data are averaged or cumulative, preferably using two time scales: per minute and per hour.

The meteorological data downloaded preferably comprise at least one of the following data: air temperature, wind speed, overall solar radiation.

The meteorological data relate to the 12 to 24 hours following the start of the mission. For example, for each position of the aircraft during the mission, the meteorological data comprise the course of the air temperature at each position of the aircraft for 12 to 24 hours.

The method 100 further comprises a step 102 of estimating, by the calculator 32, a plurality of N flammability risks for the fuel included in the fuel tank.

Each flammability risk is estimated from a single activation logic of the inerting system selected from a plurality of N activation logics of the inerting system, data relating to the preparation of the mission and meteorological data.

The flammability of the fuel is evaluated for every minute of the mission.

Fuel is said to be flammable when it releases vapours within a temperature range which, on contact with air for example, risk igniting.

A fuel is flammable when its temperature is between the LFL (Lower Flammability Limit) temperature ensuring an excessively lean mixture of fuel vapour and air, and the UFL (Upper Flammability Limit) temperature ensuring an excessively rich mixture of fuel vapour and air.

N is a non-zero natural number. For example, N may be between 2 and 10. Preferably, N is between 5 and 10.

The plurality of N activation logics is preferably stored in the memory of the calculator 32.

According to one embodiment, each flammability risk is further estimated from the flash point of the fuel loaded in the fuel tank, the flash point of the fuel being the temperature at which the fuel in the tank emits sufficient flammable gases to form with the ambient air a gas mixture which ignites from a flame.

For example, for an AVGAS type fuel, the flash point could be: −40±10 °C, and for a JET A-1 type fuel, the flash point could be: +38±12°C.

Preferably, each flammability risk is estimated by virtue of certification software, stored in the memory of the calculator 32 or accessible by the calculator 32 via a network and executed by the processor of the calculator 32.

The use of certification software to estimate each flammability risk is advantageous because certification software guarantees an evaluation of each flammability risk according to certified safety methods and criteria specific to the aircraft.

The method further includes a fourth step 103 of selecting an activation logic, among the plurality of N activation logics, from the plurality of N flammability risks estimated and from a condition relating to the inerting system.

Step 103 of selecting an activation logic is preferably made with so-called optimisation software stored in the memory of the calculator 32 or accessible by the calculator 32 via a network and executed by the processor of the calculator 32.

Preferably, the optimisation software receives as an input each activation logic from the plurality of N activation logics, each flammability risk from the plurality of N flammability risks and the condition relating to the inerting system and selects the activation logic which has made it possible to estimate a flammability risk less than or equal to a reference flammability risk estimated from the reference activation logic.

Preferably, the reference flammability risk is estimated from the reference activation logic and data relating to the preparation of the mission.

Preferably, the reference activation logic is the activation logic used for aircraft certification, from a certification organisation such as the FAA (“Federal Aviation Administration”) or the EASA (“European Union Aviation Safety Agency”).

Preferably, the reference activation logic is an activation logic during which the inerting system is in an activated operating state throughout the mission time, i.e. activated without taking the mission conditions into account, the conditions being for example the meteorological conditions and the mission preparation. In this embodiment, it is possible to estimate a flammability risk less than or equal to the reference flammability risk because, depending on the data relating to the preparation of the mission, the fuel in the fuel tank is not flammable during the entire mission time. Indeed, when the inerting system is activated during periods when the fuel is not flammable, reducing the concentration of oxygen by increasing the concentration of inert gas by virtue of the inerting system does not bring about a reduction in the additional flammability risk and the inerting system does not bring about additional protection for the fuel tank.

The condition relating to the inerting system may concern at least: the energy consumption of the inerting system, the wear of at least one piece of the inerting system, the air supply pressure to the inerting system or a combination of at least two of the elements mentioned.

By energy consumption, it is meant, for example, the amount of air used to supply the inerting system.

For example, if the inerting system condition concerns the energy consumption of the inerting system, the condition may be a minimisation of the energy consumption of the inerting system. The determination software can determine the activation logic of the inerting system, from the plurality of N activation logics, from which the flammability risk estimated is less than or equal to the reference flammability risk and enabling a minimum energy consumption of the inerting system to be obtained. Preferably, minimising the energy consumption of an inerting system corresponds to minimising the activation time of the inerting system, i.e. the time for which the inerting system is in a so-called activated operating state during the mission time. Thus, the determination software estimates for each activation logic among the N activation logics, the activation time of the inerting system 3122 and determines the activation logic among the N activation logics from which the flammability risk estimated is less than or equal to the reference flammability risk and for which the activation time of the inerting system is minimal.

For example, if the condition relating to the inerting system concerns wear of at least one piece of the inerting system, the condition may be minimisation of wear of the piece. The piece is, for example, a filter or a membrane included in the inerting system.

The wear of the piece can be estimated from the duration of exposure of said piece to ozone at altitude; the condition relating to the inerting system can then, for example, be a minimisation of the activation time of the inerting system at altitude in order to reduce exposure time of the inerting system to ozone.

Wear of the piece can be estimated from the duration of exposure of the part to the pollution when the aircraft is on the ground or close to the ground; the condition relating to the inerting system can then, for example, be minimisation of the activation time of the inerting system on the ground in order to reduce duration of exposure of the piece to pollution.

According to one embodiment in which the condition relating to the inerting system relates to the air supply pressure to a piece of the inerting system, the condition may be minimisation of the air supply pressure to the inerting system. In this embodiment, each activation logic is a diagram representing the course of the supply pressure of the inerting system over time, wherein the inerting system can be in a first or a second so-called activated operating state during at least part of the time and/or can be in a so-called deactivated operating state during at least another part of the time. A first activated state is a state during which the air supply pressure is equal to the engine pressure; a second activated state is a state during which the air supply pressure is equal to a fraction of the engine pressure. FIG. 4 is an example of the activation logic of the inerting system according to this embodiment. Thus, the horizontal axis of the activation logic represents time and the vertical axis of the activation logic represents the air supply pressure to the inerting system. The unit of the air supply pressure is, for example, Bar or Pascal. The air supply pressure to the inerting system can take three values: Pengine, k*Pengine (written kPengine in FIG. 3) and 0 for example, with k a real factor between 0 and 1. When the air supply pressure is equal to Pengine, the inerting system is in the first activated state, when the air supply pressure is equal to kPengine, the inerting system is in the second activated state and when the air supply pressure is equal to 0, the inerting system is in a deactivated state.

Note P the air supply pressure to the inerting system and t the time over which the activation logic is defined.

In this embodiment, the activation logic selected is the logic for which the estimated flammability risk is less than or equal to the reference flammability risk, and for which both the activation time of the inerting system is minimal and the value of the integral:

$${\int }_{t = 0}^{t = Temps de mission} P . dt$$

is minimal.

Another aspect of the invention relates to a method for activating the inerting system 3131 of the fuel tank of the aircraft 31.

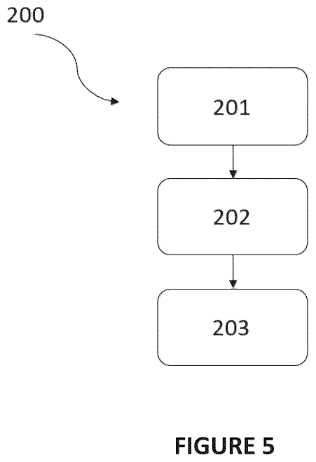

FIG. 5 represents a block diagram of the steps of the activation method 200.

The method 200 for activating the inerting system comprises a first step 201 of transmitting, by the calculator 32 to the aircraft 31 and in particular to the avionics system of the aircraft 31, the activation logic determined by the method 100 for determining an activation logic of the inerting system 3122.

The activation method 200 may comprise a step 202 of transmitting the activation logic determined, from the avionics system 311 to the electrical system 3121.

The activation method 200 further comprises a step 203 of activating the inerting system 3122 according to the activation logic determined. The step 203 of activating the inerting system 3122 is performed by virtue of the electrical system 3121 configured to emit electric power to the inerting system according to the activation logic determined.

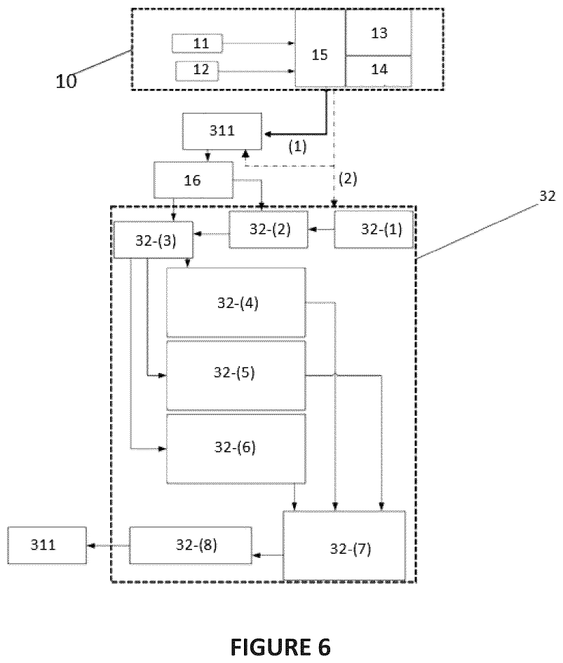

FIG. 6 is an example of an implementation of the activation logic selection method 100 represented in FIG. 4 and the activation method 200 represented in FIG. 5 for a planned aeroplane flight.

With reference to FIG. 6, reference 10 corresponds to the mission preparation performed by the pilot on/in the avionics system, or via the portable electronic device in communication with the avionics system.

With reference to FIG. 6, reference 11 corresponds to the destination to be reached and reference 12 corresponds to the type of aeroplane.

With reference to FIG. 6, reference 13 corresponds to data corresponding to a planned flight: planned flight and in particular the time of the flight, position of the aircraft during the flight and waypoint (waypoint corresponds to a fly-to-point or turning point and designates, in navigation, a point on the route to be reached where a heading change should take place).

With reference to FIG. 6, reference 14 corresponds to the amount of fuel on board the aircraft.

With reference to FIG. 6, reference 15 corresponds to mission preparation.

With reference to FIG. 6, reference 311 corresponds to the avionics system.

With reference to FIG. 6, reference (1) corresponds to one embodiment in which transmission of the mission preparation is performed by the portable electronic device to the avionics system 311.

With reference to FIG. 6, reference (2) corresponds to the embodiment in which transmission of the mission preparation is performed by the portable electronic device to both the avionics system 311 and the calculator 32.

With reference to FIG. 6, reference 16 corresponds to the transmission of the mission preparation to calculator 32.

With reference to FIG. 6, reference 32 corresponds to the calculator.

With reference to FIG. 6, reference 32-(1) corresponds to the world weather forecast for less than 24 hours.

With reference to FIG. 6, reference 32-(2) corresponds to the weather forecast for the flight.

With reference to FIG. 6, reference 32-(3) corresponds to a simulation run.

With reference to FIG. 6, reference 32-(4) corresponds to an estimate, by the certification software, of the flammability risk of fuel vapours of the aeroplane according to the first activation logic among the N activation logics.

With reference to FIG. 6, reference 32-(5) corresponds to an estimate, by the certification software, of the flammability risk of fuel vapours of the aeroplane according to the second activation logic among the N activation logics.

With reference to FIG. 6, reference 32-(6) corresponds to an estimate, by the certification software, of the flammability risk of fuel vapours of the aeroplane according to the Nth activation logic among the N activation logics. (In FIG. 6, only the estimates of the flammability risks calculated from the first, second and Nth activation logics respectively are represented for greater clarity in FIG. 6, however N flammability risks are estimated from the N activation logics in this implementation but are not represented).

With reference to FIG. 6, reference 32-(7) corresponds to the selection, by the optimisation software, of an activation logic among the N activation logics, the activation logic selected being both in accordance with a certification: for example, the activation logic selected is calculated from a flammability risk less than or equal to a flammability risk enabling the reference activation logic to be calculated and also enabling usage of the inerting system to be reduced.

With reference to FIG. 6, reference 32-(8) corresponds to a transmission of the activation logic selected to the aircraft.

With reference to FIG. 6, reference 311 corresponds to the avionics system of the aeroplane which receives the activation logic selected.

Simulations have been performed using a known flash point value and an unknown flash point value estimated by the FTFAM® certification software. For a given aircraft, these simulations showed that:
when the flash point is known to an accuracy of 1 °C, the inerting system can be deactivated for 56% of the flights made by the aircraft. In this way, the activation logic determined for 56% of the flights only comprises the deactivated operating state of the inerting system during the mission time.
When the flash point is known to an accuracy of 4 °C, the inerting system can be deactivated for 45% of the flights made by the aircraft. In this way, the activation logic determined for 45% of the flights only comprises the deactivated operating state of the inerting system during the mission time.
When the flash point is unknown (taking typical production dispersions into account), the inerting system can be deactivated during 16% of the flights made by the aircraft. Thus, the activation logic determined for 16% of the flights only comprises the deactivated operating state of the inerting system during the mission time.

1. A method for selecting an activation logic for an inerting system of at least one fuel tank of an aircraft for a mission of the aircraft, the method comprising:
transmitting data relating to the preparation of the mission to a calculator;
estimating, by the calculator, a plurality of N flammability risks of fuel included in the fuel tank, N being a non-zero natural number, each flammability risk being estimated from:
a single activation logic of the inerting system selected from a plurality of N activation logics of the inerting system, and
data relating to the preparation of the mission;
selecting an activation logic, among the plurality of N activation logics, from the plurality of N flammability risks estimated and from a condition relating to the inerting system.

2. The method according to claim 1, wherein the flammability risk estimated from the activation logic selected is less than or equal to a reference flammability risk estimated from a reference activation logic.

3. The method according to claim 2, wherein the mission comprises a phase during which the aircraft is in flight, and wherein the data relating to the preparation of the mission of the aircraft comprise at least one of the following data:
aircraft type;
mass of fuel included in the fuel tank of the aircraft prior to flight;
temperature of fuel included in the fuel tank of the aircraft prior to flight;
flight destination;
flight profile, the flight profile comprising at least one of the following data:
geographical position of the aircraft during flight;
altitude of the aircraft during flight;
air speed or Mach number during flight.

4. The method according to claim 1, wherein each flammability risk among the N flammability risks is further estimated from meteorological data.

5. The method according to claim 4, wherein each flammability risk of fuel included in the fuel tank is further estimated from the flash point of fuel included in the fuel tank, the flash point of the fuel being the temperature from which fuel included in the tank emits sufficient flammable gases to form with the ambient air a gas mixture which ignites from a flame.

6. The method according to claim 1, wherein each activation logic is a time chart representing the operating state of the inerting system over time during the mission, wherein the inerting system can be in an activated operating state during at least one part of the mission and/or can be in an deactivated operating state during at least another part of the mission.

7. The method according to claim 1, wherein the condition relating to the inerting system concerns at least:
energy consumption of the inerting system;
wear of at least one piece of the inerting system;
air supply pressure to the inerting system.

8. A method for activating the fuel tank inerting system of an aircraft, the method comprising:
transmitting to the aircraft the activation logic selected by the selection method according to claim 1;
activating the inerting system according to the activation logic selected.

9. A non-transitory computer program product comprising instructions which, when the program is executed by a computer, cause the same to implement the method according to claim 1.

10. A non-transitory computer-readable recording medium comprising instructions which, when executed by a computer, cause the same to implement the method according to claim 1.
